(19) United States
(12) Patent Application Publication
(10) Pub. No.: US 2013/0025793 A1
(43) Pub. Date: Jan. 31, 2013

(54) DEVICE FOR WELDING THERMOPLASTIC MEMBRANES

(71) Applicants: Marc Le Monnier, Clermont-Ferrand (FR); Stephane Denet, Pessac (FR); Vincent Lecocq, Quint Fonsegrives (FR)

(72) Inventors: Marc Le Monnier, Clermont-Ferrand (FR); Stephane Denet, Pessac (FR); Vincent Lecocq, Quint Fonsegrives (FR)

(73) Assignees: INNOPTICS, Talence (FR); PLASTICELL, Clermont-Ferrand (FR)

(21) Appl. No.: 13/636,841

(22) PCT Filed: Mar. 9, 2011
(86) PCT No.: PCT/FR11/50479

§ 371 Date: Oct. 17, 2012

(30) Foreign Application Priority Data
Mar. 24, 2010 (FR) 10/52111

(51) Int. Cl. B32B 37/06

(52) U.S. Cl. 156/379.6

(57) ABSTRACT

The invention relates to a device (21) for welding a first thermoplastic membrane (12) to a second thermoplastic membrane (13), in which at least the first thermoplastic membrane (12) or the second thermoplastic membrane (13) is absorbent. The invention is characterised in that the welding device (21) comprises at least one die (1) including a plurality of laser diodes (2) for emitting a laser beam (F) forming direct, simultaneous and uniform illumination on the illumination surface (23) of the first thermoplastic membrane (12).

### TECHNICAL FIELD

The invention relates to a device for laser welding thermoplastic membranes.

### BRIEF DISCUSSION OF RELATED ART

In the context of the present invention, “absorbent thermoplastic material” refers to a thermoplastic material that absorbs electromagnetic radiation with a wavelength comprised between 800 and 1200 nm. The non-filled thermoplastics are transparent to the electromagnetic radiation at a wavelength comprised between 800 and 1200 nm. However, adding an absorbent filler, such as carbon black, even in a small quantity (0.5% by mass, for example, in the case of carbon black), makes them absorbent. Thus, in the context of the present invention, “absorbent filler” refers to a material which, by being added to a thermoplastic material, makes the latter absorbent to electromagnetic radiation with a wavelength comprised between 800 and 1200 nm.

Furthermore, uniform illumination of a surface larger than 10 mm² is defined as followed. Let an elementary surface be 1 square millimeter. The illumination is said to be uniform over the surface larger than 10 square millimeters if the deviation between the average optical power received by that surface larger than 10 square millimeters and the power received by any of its elementary surfaces does not exceed 10%.

Simultaneous illumination of a surface is defined by the fact that at a given moment, all points of that surface are illuminated.

Direct illumination using laser diodes refers to illumination for which the optical power has not been guided by an optical fiber.

To ensure the sealing of various works, such as water retention basins, fish farming basins, waste burial pits, tunnel walls, building roofs, or concrete slabs before the placement of ground covers, thermoplastic membranes are used, in particular made from polymers such as high-density polyethylene (PEHD), flexible polyvinyl chloride (PVC-P), or polypropylene (PP).

These thermoplastic membranes generally assume the form of rolled sheets, the width of which is insufficient to cover the entire surface to be sealed. That is why thermoplastic membranes are cut from those rolls and arranged on the surface to be sealed in parallel so that they overlap over a width of 80 to 500 mm depending on the dimensions of the work, and sealing of the covering is achieved by hot welding.

To date, the following methods are known for performing the welding at the overlap area of thermoplastic membranes:

The first method consists of inserting an electrically heated boot between the two thermoplastic membranes to be assembled, so as to soften their surface enough for the pressure that is exerted by a metal roller placed behind the boot and bearing on the so-called upper thermoplastic membrane to cause their adhesion. Nevertheless, this method is not suitable for thermoplastic membrane less than 500 microns thick. Furthermore, the maximum welding speed cannot exceed 5 meters per minute.

The second method consists of inserting, between the sealing membranes, in place of the heating boot, a flat nozzle through which air is blown at a temperature comprised between 250 and 400° C. It then becomes possible to weld thinner thermoplastic membranes, but the highest performing devices used for this second method do not exceed the speed of 7.5 meters per minute, or only 450 meters per hour. This is very detrimental, since until the sealing of the ground or walls has been completely finished, the subsequent construction steps cannot start.

The welding devices used to perform the methods described above also have the following drawbacks:
The crushing of the softened thermoplastic membranes is done by a smooth metal roller, approximately 50 mm wide. A flatness defect caused by a flush hard body (a stone, for example) will cause a periodic welding defect.
Once this welding defect has been observed, it is not possible to reinsert the heating element between the two thermoplastic membranes to correct it. It is then necessary to act from the outside with another hot air device.
The welding device must remain permanently wedged on the section of the upper thermoplastic membrane, which requires constant monitoring. This also rules out working at night.
The welding device must be moved at a constant speed, since the heating means is not capable of adapting to speed deviations immediately. That is why, in practice, most of these welding devices are self-propelled and programs to maintain a constant speed.
The energy output of these welding devices is not high, since in the case where the welding device comprises a steel boot, the latter is too thin for it to be possible to insert the heating electric resistance therein. That is why the electric resistance is generally inserted into the vertical base on which the boot is screwed. Steel being a mediocre heat conductor, the energy loss is significant. Furthermore, the hot air blowing device also only transfers a small fraction of the energy it consumes to the plastic thermoplastic membrane areas to be welded together. In this way, the electrical consumption of these welding devices known from the state of the art can be comprised between 1500 and 5000 W as a function of the welding speed, which requires a power cable connected to a power generator.
Lastly, maintenance of these welding devices also must be provided, since the thermoplastic materials making up the membranes to be welded may become deposited on the boot or nozzle when they are very soft.

It is also well known to weld thermoplastic materials using welding devices that are equipped with laser diodes and optical fibers that channel the light emitted by said laser diodes so as to transport it to the thermoplastic membranes to be welded. Nevertheless, introducing light into an optical fiber is a costly operation that requires precise optics and alignments between the light source and the optical fiber, which inevitably creates power losses.

### BRIEF SUMMARY

The present invention resolves all or part of the drawbacks outlined above presented by the devices currently known for welding thermoplastic membranes.

In fact, the present invention proposes to provide a device for welding thermoplastic membranes making it possible to:
obtain a sealed and continuous weld, even if the ground or substrate is not smooth,
if necessary, repair periodic welding defects.

Furthermore, with a welding device according to the invention, it is no longer crucial during welding to:
precisely follow the edge of the upper thermoplastic membrane,
maintain a slow and constant speed.

Lastly, the welding device according to the invention does not require frequent cleaning as mentioned above, and above all, it has a simple design, i.e. it does not require particular and complex optics.

The welding device according to the invention for welding a first thermoplastic membrane to a second thermoplastic membrane, in which at least the first thermoplastic membrane or the second thermoplastic membrane is absorbent, is characterized in that it comprises at least one die including a plurality of laser diodes for emitting a laser beam F forming direct, simultaneous and uniform illumination on the illumination surface of the first thermoplastic membrane.

Thus, owing to the plurality of laser diodes for emitting a laser beam F forming direct, simultaneous and uniform illumination comprised by the welding device according to the invention, it is also possible to avoid using one or more movable mirrors, which are expensive and fragile, and the position of which must also be subjugated to scan in one or two dimensions, so as to generate a uniform power density when averaged over time.

The design of the welding device according to the invention is simplified as a result and gains robustness, as there are no moving parts, and the transmission of the energy to the thermoplastic membranes to be welded is optimal.

Furthermore, owing to this uniform, direct and simultaneous illumination, it is not necessary for an optical fiber to channel the light emitted by the laser diodes and transported to said thermoplastic membranes to be welded, which also contributes to simplifying the design of the welding device according to the invention.

Advantageously, the welding device also comprises at least one waveguide.

In one embodiment of the invention, the welding device also comprises at least one means for putting the first thermoplastic membrane in contact with the second thermoplastic membrane. This contact means is designed so as to exert sufficient pressure at the illumination surface by the laser beam F for the first and second thermoplastic membranes to be able to exchange calories by conduction.

Preferably, the welding device also comprises at least one calorie draining means for avoiding heat degradation of the illumination surface of the first thermoplastic membrane. Said calorie draining means has a much higher thermometric conductivity than that of the thermoplastic polymer from which the first thermoplastic membrane is made, which allows it to drain the calories generated by the laser radiation outside the upper surface of the first thermoplastic membrane.

Preferably, said laser diodes each emit a laser ray with a wavelength comprised between 800 and 1200 nm.

Advantageously, the laser diodes are laser diodes that each emit a laser ray perpendicular to the substrate from which they are made.

Very preferably, the laser diodes are laser diodes of the VCSEL (“Vertical Cavity Surface Emitting Laser”) type.

Advantageously, the welding device comprises a plurality of waveguides and a plurality of dies arranged so that at least one of said waveguides guides at least one of said laser beams F emitted by the plurality of laser diodes of said plurality of dies.

In one embodiment of the invention, the welding device comprises a plurality of waveguides and a plurality of dies arranged so that each waveguide guides a laser beam F emitted by the plurality of laser diodes of a corresponding die.

Advantageously, the calorie draining means is inserted between the laser beam F and the first thermoplastic membrane and has a coefficient of heat transfer λ much higher than that of the first thermoplastic membrane. Preferably, this coefficient of heat transfer λ is greater than 30 W/m·K at 20° C.

Advantageously, the welding device comprises at least one synthetic sapphire or synthetic diamond bar. The waveguide, the means for putting the first thermoplastic membrane in contact with the second thermoplastic membrane, and the calorie draining means for avoiding heat degradation of the illumination surface of the first thermoplastic membrane can be accumulated in such a synthetic sapphire or synthetic diamond bar. This has the advantage of simplifying the welding device according to the invention.

In one embodiment, the welding device can comprise at least one plate of transparent material that performs the functions of the calorie draining means and the means for putting the first thermoplastic membrane in contact with the second thermoplastic membrane. Preferably, the plate of transparent material is a plate of synthetic sapphire or synthetic diamond.

In one embodiment where the welding device comprises such a synthetic sapphire or synthetic diamond plate, the welding device can also comprise a glass bar that performs the waveguide function.

These embodiments thus described have the advantages of simplifying the design of the welding device according to the invention.

Preferably, the waveguide comprises at least one diopter in the form of a notch.

Preferably, the device according to the invention comprises at least one means for putting the first thermoplastic membrane in contact with the second thermoplastic membrane that includes elastic deformation elements.

Advantageously, the welding device according to the invention includes a power source that is an energy source of the battery type.

The welding device according to the invention may comprise movement means allowing it to be moved during the welding.

The welding device according to the invention may also comprise a means allowing the heat produced in the first thermoplastic membrane to propagate into the second thermoplastic membrane. Advantageously, this means is a Teflon® pad.

Preferably, the power emitted by the laser beam F depends on the welding speed of the welding device.

Advantageously, the laser beam F is made over several lines.

In one embodiment, the welding device also comprises at least one optical system designed so that the direct, simultaneous and uniform illumination formed by the laser beam F emitted by the plurality of laser diodes is in the object focal plane so as to obtain a magnification to spread the power of the laser beam F in the image plane.

Advantageously, the optical system also comprises at least two mirrors arranged on either side of the laser beam F so as to contain its optical power in a direction transverse to the movement of the welding device and spread it in the direction of movement of said welding device. Said at least two mirrors can have an adjustable spacing.

In one embodiment of the invention, said at least two mirrors perform the function of the means for putting the first thermoplastic membrane in contact with the second thermoplastic membrane.

Preferably, said optical system comprises at least one lens.

In one embodiment of the invention, the welding device also comprises at least one means for crushing the first thermoplastic membrane on the second thermoplastic membrane. This crushing means allows crushing of the first and second thermoplastic membranes at the areas softened by the heat so as to cause an interpenetration of the material between those thermoplastic membranes.

### BRIEF DESCRIPTION OF THE DRAWINGS

The invention will be better understood using the detailed description provided below in light of the appended drawing, showing, as a non-limiting example, one embodiment of the present invention.

FIG. 1 is a diagrammatic front view of the die including a plurality of VCSEL laser diodes comprised by the welding device according to the invention.

FIG. 2 is a diagrammatic view of an embodiment of the invention in which the welding device comprises a die including a plurality of laser diodes.

FIG. 3a is a diagrammatic perspective view of a synthetic sapphire bar comprised by the welding device according to the invention.

FIG. 3b is a diagrammatic perspective view of a glass bar, as well as a synthetic sapphire plate comprised by the welding device according to the invention.

FIG. 4a is a front diagrammatic view of a die of VCSEL laser diodes mounted on a synthetic sapphire bar used as means for putting the first thermoplastic membrane in contact with the second thermoplastic membrane, and which is completed by other contact means in the form of springs comprised by the welding device according to the invention.

FIG. 4b is a diagrammatic side view of the die and the strip shown in FIG. 4a.

FIG. 4c is a view similar to FIG. 4b with a synthetic sapphire bar whereof the lower end comprises a Teflon® pad.

FIG. 5 is a diagrammatic front view of an assembly including a plurality of VCSEL laser diode dies aligned in a single row, each of said dies being mounted on a synthetic sapphire bar.

FIG. 6 is an enlarged partial view of the assembly shown in FIG. 5 bearing on two thermoplastic membranes to be welded.

FIG. 7a is a diagrammatic view of one embodiment of the invention in which the welding device is equipped with an optical system comprising a lens.

FIG. 7b is a view similar to FIG. 7a in which the welding device is also equipped with a synthetic sapphire plate.

FIG. 8a is a diagrammatic view of the embodiment of the invention shown in FIG. 7b in which the welding device also comprises two mirrors.

FIG. 8b is a diagrammatic side view of the embodiment shown in FIG. 8a.

FIG. 9 is a diagrammatic side view of a welding device according to the invention shown in the form of a wagon.

FIG. 10 is a diagrammatic view of the back of the wagon shown in FIG. 9.

### DETAILED DESCRIPTION

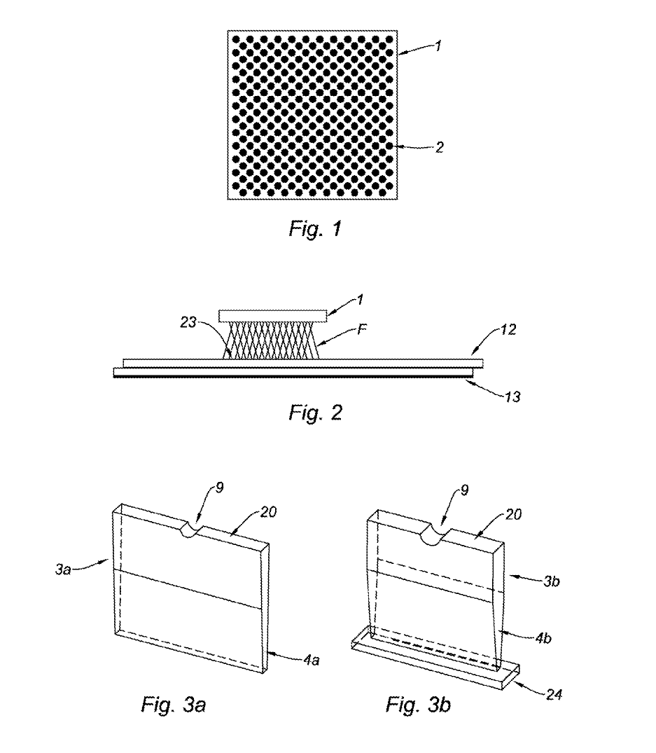

FIG. 1 is a diagrammatic front view of a die 1 including a plurality of VCSEL laser diodes 2 comprised by the welding device 21 according to the invention. The laser diodes 2 are arranged in staggered rows on the surface of the die 1 very densely, i.e. in the vicinity of several hundred diodes per square millimeter. The die 1 has a square surface. In other embodiments of the invention, the die 1 may for example have a rectangular surface.

The welding device 21 according to the invention may comprise laser diodes called “conventional” (“edge emitters”), i.e. which emit by the edge, or laser diodes that emit a laser ray perpendicular to the substrate from which they are made. It is, however, more advantageous for the welding device 21 to comprise the latter parts, and still more preferably laser diodes of the VCSEL type.

In fact, the laser diodes of the VCSEL type have the advantage of being able to be manufactured in the form of a die or a plurality of dies with a very high density as mentioned above. In fact, each VCSEL laser diode emits over a reduced surface and parallel to the other VCSEL diodes. Using a die or a plurality of dies of VCSEL laser diodes, illuminations of several kW/cm² can be obtained that are completely comparable to the illuminations obtained with so-called “edge emitter” laser diodes and with the following technical advantages:
a capacity to work at higher temperatures, i.e. up to a junction temperature of 100° C., and without risk of deterioration, and especially
a circular optical beam of excellent quality, i.e. monomode and only slightly divergent (maximum angle of 10° in relation to the normal of the emitting surface).

Furthermore, the sum of all of the beams coming from these VCSEL laser diodes 2 procures completely uniform illumination at several millimeters from the emitting surface. Satisfying this uniformity criterion is crucial in the context of the present invention. In fact, the thermoplastic materials making up the first and second thermoplastic membranes 12, 13 to be welded are poor heat conductors. It is therefore crucial for the increase in the temperature up to the softening of those materials to be the same at each moment at all points of the surface to be welded of said thermoplastic membranes.

With a plurality of dies 1 of VCSEL laser diodes 2 aligned in a row, it is possible to generate a laser beam F (or in other words a “line”) several centimeters long and several millimeters wide at a distance from the emitting surface smaller than 100 mm. This makes it possible to dimension the welding device 21 in a very compact manner.

In one embodiment of the invention, the VCSEL laser diodes 2 emit from the bottom, which makes it possible to cool them passively, and therefore to do away with cooling using water circulation. Their energy output, i.e. the ratio of the optical power emitted to the electrical power supplied, today is in the vicinity of 50%, and developments in progress will soon make it possible to exceed 60%.

All of the dies 1 of VCSEL laser diodes 2 can be powered by a 6 V or 12 V battery capable of ensuring full-rating operation of all of the laser diodes 2 for at least 4 hours. In this way, this procures the advantage for the welding device 21 of not having to have a wired connection, which greatly facilitates its use, and in particular in locations that are often not very accessible where thermoplastic membranes are placed.

FIG. 3a is a diagrammatic perspective view of a synthetic sapphire bar 3a with a parallelepiped shape with a beveled lower end 4a comprised by the welding device 21.

Due to their angle of incidence and the difference between the refraction indices of the air and of the synthetic sapphire bar 3a, the beams emitted by the laser diodes 2 reflect on its walls and overlap to form a uniform illumination at the outlet of said synthetic sapphire bar 3a, i.e. in direct contact with the first thermoplastic membrane 12.

The synthetic sapphire bar 3a shown in FIG. 3a in particular performs the function of the waveguide of the welding device 21. It comprises a lower end 4a and a notch 9 with a particular shape of the inlet surface 20. The notch 9 comprises a diopter of the “mouse bite” type. The profile of this notch 9 is optimized to spread the optical power uniformly lengthwise at the outlet of said synthetic sapphire bar 3a, which makes it possible to reduce the height thereof and to arrange a very compact welding device 21 while generating a longer “line” or laser beam F.

The synthetic sapphire bar 3a has undergone an anti-reflective treatment on the inlet surface 20 and on the surface in contact with the first thermoplastic membrane 12, which makes it possible to obtain a transmission rate close to 100% between 800 and 1200 nm.

Furthermore, the coefficient of heat transfer λ of the synthetic sapphire is 40 W/m·K at 20° C. (value 100 times higher than that of the thermoplastic membranes). That is why the synthetic sapphire bar 3a is also a calorie draining means for preventing heat degradation of the illumination surface 23 of the first thermoplastic membrane 12 of the welding device 21.

Also, as shown in FIG. 6, the synthetic sapphire bar 3a is a means for putting the first thermoplastic membrane 12 in contact with the second thermoplastic membrane 13. In fact, due to the pressure it exerts on the first thermoplastic membrane 12, it guarantees heat conduction between said first thermoplastic membrane 12 and the second thermoplastic membrane 13.

The welding device 21 according to the invention may comprise a glass bar 3b and a synthetic sapphire plate 24 as shown in FIG. 3b. The glass bar 3b comprises a lower end 4b. In such an embodiment of the invention, the synthetic sapphire plate 24 performs the functions of the calorie draining means and the means for putting the first thermoplastic membrane 12 in contact with the second thermoplastic membrane 13 and the glass bar 3b performs the waveguide function.

In another embodiment of the invention not shown, the welding device 21 can comprise a synthetic diamond bar of the CVD (Chemical Vapor Deposition) type, which offers transparency equivalent to that of the synthetic sapphire, but with a coefficient of heat transfer λ greater than 1000 W/m·K at 20° C. The maximum thickness currently available on the market for such a synthetic diamond bar is 1 mm. This synthetic diamond can also, like the synthetic sapphire plate 24, perform the functions of the calorie draining means for avoiding heat degradation of the illumination surface 23 of the first thermoplastic membrane 12 on the second thermoplastic membrane 13 and the means for putting the first thermoplastic membrane 12 in contact with the second thermoplastic membrane 13 of the welding device 21.

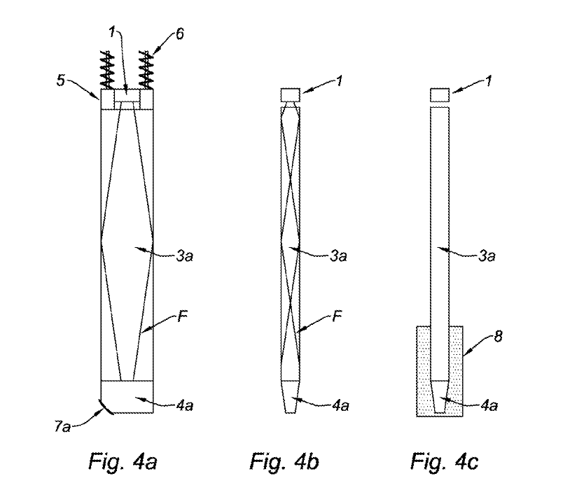

In FIG. 4a, the die 1 is positioned several millimeters above a synthetic sapphire bar 3a whereof the lower end 4a is beveled to reduce the width of the laser beam F. Supports 5, providing the connection between the die 1 and the synthetic sapphire bar 3a, serve as a base for helical springs 6, which are fastened to a stationary part (not shown) of the welding device 21. The supports 5 and the helical springs 6 are one embodiment of a means for putting the first thermoplastic membrane 12 in contact with the second thermoplastic membrane 13 comprised by the welding device 21. Other embodiments of such means for putting the first thermoplastic membrane 12 in contact with the second thermoplastic membrane 13 are within the reach of one skilled in the art.

The helical springs 6 have a stiffness such that they can exert sufficient pressure on the first thermoplastic membrane 12 to ensure its contact with the second thermoplastic membrane 13. Furthermore, the helical springs 6 ensure permanent contact of the synthetic sapphire bar 3a on the first thermoplastic membrane 12 to offset any flatness defects of the substrate to be sealed, which represents an important advantage of the welding device 21.

As shown in FIG. 4a, the synthetic sapphire bar 3a comprises a round-off 7a in the direction of forward movement of the welding device 21, which allows it not to catch the first thermoplastic membrane 12 during the welding.

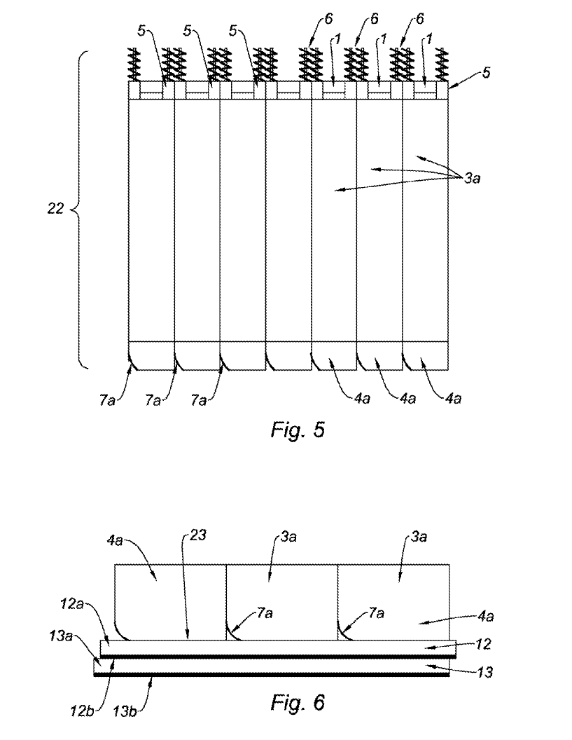

In FIG. 5, an assembly 22 is shown that includes:
a plurality of dies 1 including a plurality of VCSEL laser diodes 2,
a plurality of synthetic sapphire bars 3a above which said dies 1 are arranged,
a plurality of supports 5 providing the connection between a die 1 and a synthetic sapphire bar 3a,
a plurality of springs 6 fastened to said supports 5.

As shown in FIG. 5, the dies 1 and the synthetic sapphire bars 3a are aligned jointly so as to form a quasi-continuous surface at the contact area with the first thermoplastic membrane 12.

Furthermore, in one embodiment of the invention not shown, the waveguide, for example in the form of a synthetic sapphire bar 3a, can have a length such that above it, several dies 1 of laser diodes 2 are aligned. In fact, as a function of the power density and the desired length of the laser line, the beams of several dies 1 can be injected into a same waveguide and overlap to form a uniform line at the outlet of said means. However, this embodiment is only appropriate when the substrate to be sealed is completely flat.

FIG. 6 diagrammatically shows the synthetic sapphire bars 3a shown in FIG. 5 bearing on the first thermoplastic membrane 12 where said first thermoplastic membrane 12 overlaps with the second thermoplastic membrane 13.

As shown in FIG. 6, the first thermoplastic membrane 12 comprises a transparent layer 12a and an absorbent layer 12b. The layer 12b contains carbon black. The second thermoplastic membrane 13 comprises a transparent layer 13a and an absorbent layer 13b. The layer 13b contains carbon black.

Preferably, the first and second thermoplastic membranes 12, 13 respectively comprise two layers of thermoplastic material, i.e.:
a transparent layer 12a, 13a, i.e. not filled and therefore transparent to the radiation of the laser diodes 2 comprised by the welding device 21, and
an absorbent layer 12b, 13b, approximately 50 microns thick, which contains at least 0.5% carbon black.

Such bi-layer materials are commonly produced:
by extrusion blow molding in the case of PEHD, and
by calendaring in the case of PVC.

Their price is identical to that of single-layer materials containing carbon black.

The welding speed of the welding device 21 on such bi-layer thermoplastic membranes can reach 30 meters per minute.

However, the welding device 21 is also completely adapted to weld:
a first thermoplastic membrane 12 that comprises a transparent layer 12a and an absorbent layer 12b on a second transparent single-layer thermoplastic membrane 13,
a first thermoplastic membrane 12 that comprises a transparent layer 12a and an absorbent layer 12b on a second absorbent single-layer thermoplastic membrane 13,
a first transparent single-layer thermoplastic membrane 12 on a second absorbent single-layer thermoplastic membrane 13.

Furthermore, in the context of the present invention, the thermoplastic materials from which the first and second thermoplastic membranes 12, 13 are made are advantageously chosen among PVC, PEHD, and PP.

As shown in FIG. 6, the lower ends 4a of the synthetic sapphire bars 3a bear on the transparent layer 12a of the first thermoplastic membrane 12. The laser beam F guided by the synthetic sapphire bars 3a forms a uniform, direct and simultaneous illumination of the illumination surface 23 of the first thermoplastic membrane 12, which passes through the transparent layer 12a without being absorbed. The temperature of the absorbent layer 12b then increases very quickly due to the conversion into heat of the electromagnetic energy from the laser beam F that passed through said transparent layer 12a. This conversion into heat is obtained by vibrating (i.e. implementing a resonance phenomenon) the carbon black molecules present in said absorbent layer 12b. The heat thus released propagates by heat conduction to the transparent layer 13a of the second thermoplastic membrane 13 on which the first thermoplastic membrane 12 overlaps. This transparent layer 13a also starts to soften, or even melt in the case of a semi-crystalline polymer.

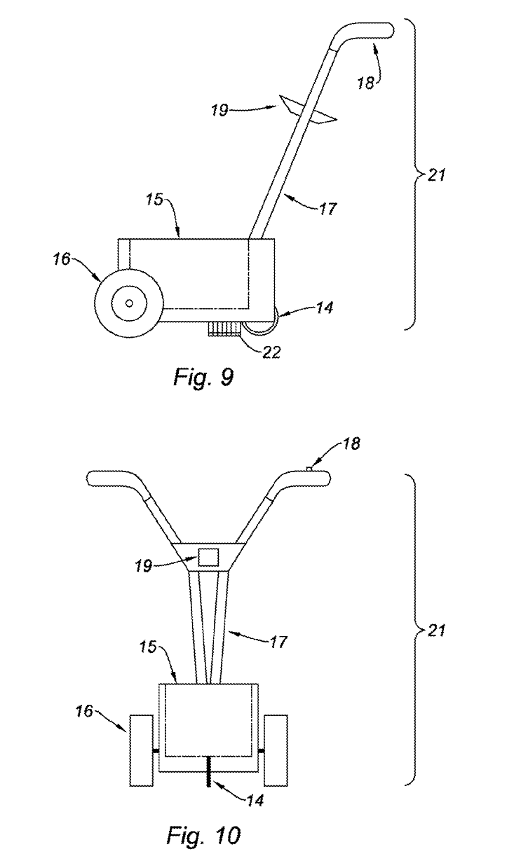

The heat flow also propagates in the transparent layer 12a, but the synthetic sapphire bar 3a, which is a good heat conductor due to its high enough coefficient of heat transfer λ, absorbs the calories near the surface of the layer 12a and thus prevents the heat degradation of the illumination surface. As a result, the welding of the first and second thermoplastic membranes 12, 13 obtained is of high quality, since the crushing pressure is exerted on that layer 12a, in particular using the pressing wheel 14 as shown in FIGS. 9 and 10. This is a fundamental aspect of the present invention.

More specifically, the pressing wheel 14, due to the high pressure it exerts, forces the interpenetration of the macromolecules respectively making up the first and second thermoplastic membranes 12, 13, said macromolecules having become mobile under the effect of the heat generated by the direct, simultaneous and uniform illumination of the illumination surface 23 of said first thermoplastic membrane 12.

After cooling, a weld is obtained that is as strong as the material from which the first and second thermoplastic membranes 12, 13 are made.

Furthermore, because the heat degradation of the illumination surface 23 is avoided, as a result there is no risk of dirtying of the surface of the synthetic sapphire bar 3a or the pressing wheel 14. In this way, the present invention proposes a welding device 21 for welding a first thermoplastic membrane 12 to a second thermoplastic membrane 13 that does not encounter dirtying problems during welding.

As explained for FIG. 4a, owing to the springs 6, the welding device 21 is completely capable of adapting to irregularities on the surface of the substrate to be sealed, and the first thermoplastic membrane 12 that receives the radiation is always kept pressed on the second thermoplastic membrane 13, while avoiding heat degradation of the surface of the transparent layer 12a owing to the synthetic sapphire bars 3a.

FIG. 4c illustrates another embodiment of the invention, when it involves welding two thermoplastic membranes 12, 13 in the form of absorbent single-layer thermoplastic membranes. To that end, in the embodiment of the invention illustrated in FIG. 4c, a Teflon® pad 8, for example 1 mm thick, is arranged at the lower end 4a of the synthetic sapphire bars 3a. Thus, the Teflon® pad 8 is a means intended to propagate the heat produced in the first thermoplastic membrane 12 toward the second thermoplastic membrane 13.

In fact, in the particular case of thermoplastic membranes made from PEHD or PP permanently exposed to sunlight, a bi-layer material as described above is not possible, since the low ultraviolet resistance of PP and, to a lesser extent, of non-filled PEHD, may cause cracks and fissures in the transparent layer. That is why it is necessary to use single-layer absorbent thermoplastic membranes that contain an absorbent filler (for example, carbon black) when said thermoplastic membranes are exposed to ultraviolet rays.

The Teflon® pad 8 then acts as a layer transparent to the laser beam F, which transmits nearly all of the electromagnetic energy to the first absorbent single-layer thermoplastic membrane 12. The synthetic sapphire bar 3a cools the Teflon® pad 8. Teflon® being as poor a heat conductor as the first thermoplastic membrane 12, it only absorbs part of the heat produced in that first thermoplastic membrane 12 and thereby allows it to propagate downward to the second thermoplastic membrane 13 on which it bears.

Up to a certain limit, the Teflon®, through its contact, prevents heat degradation of the surface of the first thermoplastic membrane 12 by the oxygen from the air.

In this embodiment of the invention, the thickness of the first and the second thermoplastic membranes 12, 13 is limited to 300 microns, given that the heat finds it difficult to propagate in the thermoplastic membranes 12, 13, and the welding speed is significantly lower than with a transparent/absorbent bi-layer material, but it may be greater than 10 meters per minute.

It should be noted that the Teflon® pad 8 represents one possible means that may be comprised by the welding device 21 to weld absorbent single-layer thermoplastic membranes, i.e. which comprises absorbent filler such as carbon black. Other means equivalent to the Teflon® pad 8 are within the reach of one skilled in the art.

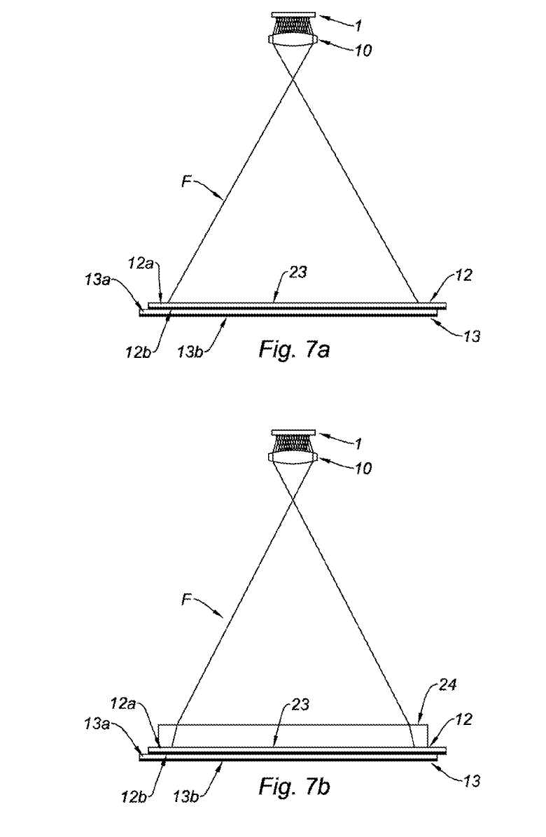

FIG. 7a shows one embodiment of the invention, in which an adaptive focal lens 10 is arranged across from the die 1 including a plurality of VCSEL laser diodes 2, such that a uniform illumination is found in the object focal plane and so as to obtain a sufficient magnification to spread the power of the laser beam F in the image plane.

The lens 10 used is adapted in relation to the magnification one wishes to produce between the source and the illuminated area. In the event a lens with symmetry of revolution is used, a same form factor will be obtained for the irradiated area and the source.

The lens 10 produces the image of the uniform illumination obtained by the plurality of laser diodes 2 of the die 1 on the illumination surface 23. The laser beam F is allowed to widen in the direction of the movement of the welding device 21. FIG. 7b shows an embodiment of the invention fairly similar to that shown in FIG. 7a, with the difference that the welding device also comprises a synthetic sapphire plate 24 that makes it possible, as was described above, to avoid heat degradation of the illumination surface 23 of the first thermoplastic membrane 12, as well as ensuring that the first thermoplastic membrane 12 is put in contact with the second thermoplastic membrane 13.

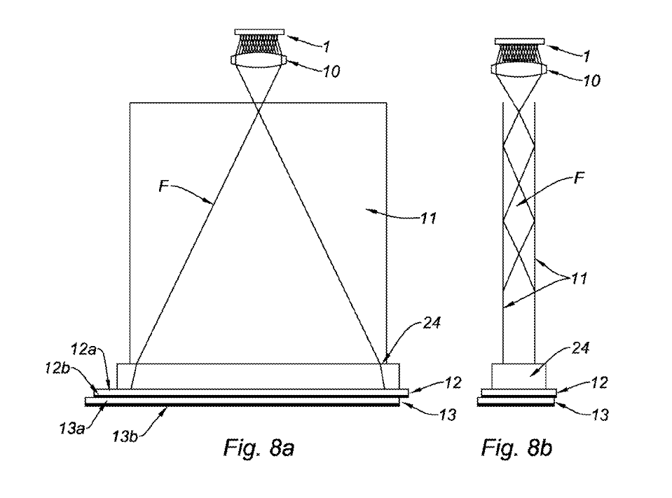

However, and as illustrated in FIGS. 8a and 8b, in order to contain the laser power over a narrow energy line, or in other words to have a long and thin line as previously described, two mirrors 11 are placed on either side of the laser beam F to contain its optical power in a direction transverse to the movement of the welding device 21 and allowing it to spread in the direction of movement of the welding device 21. The adjustment of the distance between the two mirrors 11 may be adjustable to allow the operator to adjust the width of the welding to his liking. Under these mirrors 11, a synthetic sapphire plate 24 is mounted performing the functions as described above, in particular in reference to FIG. 7b.

In one embodiment of the invention not shown, the welding device 21 may be similar to that shown in FIG. 8a, except that it does not include a synthetic sapphire plate 24. In that embodiment, the mirrors 11 then also serve to ensure the contact between the first thermoplastic membrane 12 and the second thermoplastic membrane 13.

FIG. 9 shows one possible embodiment of the welding device 21 according to the invention, i.e. in the form of a wagon. More specifically, the wagon 21 includes:
an electric battery 15, the advantages of which for the easy use of the welding device 21 have already mentioned above,
a front axle provided with wheels having tires 16,
handlebars 17,
a handle provided with a pushbutton 18, and
a device for adjusting and storing the welding power 19.

In fact, the welding device 21 may be equipped with a device for adjusting the radiated power so as to optimize the welding speed as a function of the characteristics of the thermoplastic membranes to be welded.

Preferably, the welding device 21 operates in digital mode so as to allow several adjustments to be stored.

A pressing wheel 14 is mounted at the rear of the wagon 21, aligned with its longitudinal axis so as to constitute another bearing point of said wagon 21. Advantageously, this pressing wheel 14 is made from rubber. Furthermore, this pressing wheel 14 is mounted just behind and aligned with the assembly 22 (as shown in FIG. 5), said assembly 22 also being placed along the longitudinal axis of the wagon 21.

In this way, the rubber pressing wheel 14, by rolling without sliding, exerts strong pressure on the areas radiated by the laser beam F there in a fluid or paste state in and in the immediate vicinity of the absorbent layer 12b. This then allows the tangling (or in other words, the interpenetration) of the macromolecules between the absorbent layer 12b and the transparent layer 13a, and as has already been mentioned above.

Preferably, the width of the pad of the pressing wheel 14 corresponds to twice the width of the laser beam F to avoid leaving a hollow mark. This width remains smaller than or equal to 10 mm. This small width and the compressibility of the rubber from which the pressing wheel 14 is advantageously made make it possible to secure the sealing of the weld on irregular ground, which cannot be done with a non-deformable metal roller 50 mm wide used in the welding devices of the state of the art described above.

Preferably, the pressing wheel 14 is also mounted on a spring suspension.

FIG. 10 diagrammatically shows the wagon 21 shown in FIG. 9, but from the back. The weight of the battery 15 is distributed equally on the pressing wheel 14 and the wheels 16. The user then pushes the wagon 21 without lifting it using the handlebars 17 and by continuously exerting pressure on the switch mounted on the handle 18. Advantageously, a low, but continuous sound signal informs the user that the welding device 21 is running. If he releases the pressure on the handle 18, the electricity is cut. A start/stop switch integrated into the adjustment housing 19 provides additional security.

If needed, a light, for example red, can be injected into the waveguides to indicate a burn risk.

The total emitted power is limited to 300 W to allow a welding speed of 30 meters per minute, or 1.8 km/h, which means that the maximum consumption of the welding device 21 is 600 W.

Furthermore, in one embodiment of the invention not shown, the welding device 21 comprises a movement sensor, which may be optical. This makes it possible to automatically and instantaneously adjust the intensity of the current powering the laser diodes 2, which guarantees a constant and optimized illumination on the first thermoplastic membrane 12 expressed in Watts per square millimeters irrespective of the variations in the movement speed of the welding device 21.

Furthermore, the welding device 21 can be provided with at least two laser lines. It is then possible to continuously or sequentially produce two parallel weld lines, which guarantees complete sealing of the work.

In another embodiment of the invention not shown, it is possible to mount the dies 1 including a plurality of laser diodes 2 with the waveguide and the contact and calorie draining means in a plastic case, and to connect them to a battery 15 using a cable. This thus makes it possible to make truck covers, advertising canvas, tent canvas, pool covers more quickly and more flexibly than with the current tools.

In one embodiment not shown, the welding device 21 can also be a manual device that comprises at least one assembly 22 as shown in FIG. 5 as well as a pressing wheel 14. This type of device is particularly suited to welding thermoplastic membranes designed to provide sealing in tunnels or on the paving stones of residences.

Furthermore, in one embodiment of the invention not shown, the welding device 21 can be a device not moving during operation, but under which the first and second thermoplastic membranes 12, 13 pass (for example using a conveyor belt), said welding device 21 being designed so as to weld said first and second thermoplastic membranes 12, 13 at their overlap areas.

The thermoplastic membranes to be welded can also be small surfaces, such as the thin inner membrane of a mobile telephone, for example, the plastic shell of the device acting as the second membrane.

The present invention thus procures the following advantages:
The welding device 21, due to its low energy consumption, can be powered by one or more batteries that may be recharged overnight.
The high welding speed, in the vicinity of 30 meters per minute, of the welding device 21 makes it possible to perform sealing work in one day currently requiring one week using the known welding devices.
Furthermore, unlike the known welding devices, the welding device 21 introduces heat from the outside and not between the first and second thermoplastic membranes 12, 13, while keeping the illumination surface 23 of the first thermoplastic membrane 12 in contact with the welding device 21. It is therefore possible at any time to retouch a weld line by simply passing over it again at the location of the flaw.
The welding device 21 has a certain longevity, in particular when it comprises VCSEL laser diodes.

Lastly, it should be noted that the welding device 21 according to the invention can be used in multiple industrial applications, in particular including those of worksites where geo-membranes or plastic sealing layers are placed.

1. A device for welding a first thermoplastic membrane to a second thermoplastic membrane, in which at least the first thermoplastic membrane or the second thermoplastic membrane is absorbent, said welding device comprising at least one die including a plurality of laser diodes for emitting a laser beam forming direct, simultaneous and uniform illumination on the illumination surface of the first thermoplastic membrane.

2. The welding device according to claim 1, wherein the welding device also comprises at least one waveguide.

3. The welding device according to claim 1, wherein said welding device also comprises at least one means for putting the first thermoplastic membrane in contact with the second thermoplastic membrane.

4. The welding device according to claim 1, wherein said welding device also comprises at least one calorie draining means for avoiding heat degradation of the illumination surface of the first thermoplastic membrane.

5. The welding device according to claim 1, wherein the laser diodes are laser diodes of the VCSEL type.

6. The welding device according to claim 2, wherein said welding device comprises a plurality of waveguides and a plurality of dies arranged so that at least one of said waveguides guides at least one of said laser beams emitted by the plurality of laser diodes of said plurality of dies.

7. The welding device according to claim 6, wherein each waveguide guides a laser beam emitted by the plurality of laser diodes of a corresponding die.

8. The welding device according to claim 4, wherein the calorie draining means is inserted between the laser beam and the first thermoplastic membrane and has a coefficient of heat transfer greater than 30 W/m·K at 20° C.

9. (canceled)

10. The welding device according to claim 1, wherein said welding device comprises at least one bar of synthetic sapphire or synthetic diamond.

11. The welding device according to claim 3, wherein said welding device comprises at least one plate of synthetic sapphire or synthetic diamond.

12. The welding device according to claim 11, wherein said welding device also comprises at least one glass bar.

13. The welding device according to claim 3, wherein the welding device comprises at least one means for putting the first thermoplastic membrane in contact with the second thermoplastic membrane that includes elastic deformation elements.

14. The welding device according to claim 1, wherein said welding device also comprises at least one means for crushing the first thermoplastic membrane on the second thermoplastic membrane.

15. The welding device according to claim 1, wherein the power emitted by the laser beam depends on the welding speed of the welding device.

16. The welding device according to claim 1, wherein the laser beam is made over several lines.

17. (canceled)

18. (canceled)

19. The welding device according to claim 1, wherein said welding device also comprises at least one optical system designed so that the direct, simultaneous and uniform illumination formed by the laser beam emitted by the plurality of laser diodes is in the object focal plane so as to obtain a magnification to spread the power of the laser beam in the image plane.

20. The welding device according to claim 19, wherein said optical system also comprises at least two mirrors arranged on either side of the laser beam so as to contain its optical power in a direction transverse to the movement of the welding device and spread it in the direction of movement of said welding device.

21. The welding device according to claim 20, wherein said at least two mirrors have an adjustable spacing.

22. (canceled)

23. The welding device according to claim 1, wherein said welding device includes a power source that is an energy source of the battery type.

24. The welding device according to claim 1, wherein said welding device comprises movement means allowing it to be moved during the welding.
